(19) United States
(12) Patent Application Publication
(10) Pub. No.: US 2025/0197171 A1
(43) Pub. Date: Jun. 19, 2025

(54) HOOK POSITION CALCULATION DEVICE

(71) Applicant: KOBELCO CONSTRUCTION MACHINERY CO., LTD., Hiroshima-shi (JP)

(72) Inventors: Hitoshi SAKURAI, Hyogo (JP); Kenichi TERAUCHI, Hiroshima (JP); Shintaro SASAI, Hyogo (JP); Yoshihito TAKEYA, Hyogo (JP)

(73) Assignee: KOBELCO CONSTRUCTION MACHINERY CO., LTD., Hiroshima-shi (JP)

(21) Appl. No.: 18/846,131

(22) PCT Filed: Mar. 9, 2023
(86) PCT No.: PCT/JP2023/009013

§ 371 Date: Sep. 11, 2024

(30) Foreign Application Priority Data
Mar. 17, 2022 (JP) 2022-042148

(51) Int. Cl. B66C 13/46; B66C 13/08

(52) U.S. Cl. CPC B66C 13/46; B66C 13/085

(57) ABSTRACT

A storage unit stores hoisting height error information about a hoisting height error associated with magnitude of a derricking angle of an attachment and magnitude of a lifting load. The hoisting height error is the difference between a hoisting height calculation value and an actual hoisting height of a hook. An arithmetic unit calculates a hoisting height calculation value based on a derricking angle detection value that is the derricking angle detected by an attachment angle sensor and a winding amount detection value that is a winding amount detected by a winding amount sensor. The arithmetic unit uses the hoisting height error information to determine a hoisting height error corresponding value that is the hoisting height error corresponding to the derricking angle detection value and a lifting load detection value, and corrects the hoisting height calculation value based on the determined hoisting height error corresponding value.

### TECHNICAL FIELD

The present invention relates to a hook position calculation device that calculates a hook position of a crane.

### BACKGROUND ART

For example, Patent Literature 1 and the like describe a technology for obtaining information about a hook position (hoisting height of suspended load in Patent Literature 1). The technology described in Patent Literature 1 calculates information about the hook position from a movement amount of a winding rope and a derricking angle of an attachment (see the abstract of Patent Literature 1 and paragraphs and of the specification, and the like).

However, due to the derricking angle of the attachment, a lifting load acting on the winding rope, and the like, the deflection amount of the attachment changes, and the hook position changes. Due to the lifting load acting on the winding rope or the like, the slack (stretch) amount of the winding rope changes, and the hook position changes. The technology described in Patent Literature 1 does not take into account the change in the hook position due to the deflection of the attachment and the slack of the winding rope. Therefore, information about the hook position cannot be calculated with high accuracy.

### CITATION LIST

### Patent Literature

Patent Literature 1: JP 2001-146385 A

### SUMMARY OF INVENTION

Therefore, an object of the present invention is to provide a hook position calculation device that can calculate information about the hook position with high accuracy.

The hook position calculation device includes a machine body, an attachment, a winding rope, a hook, a winding winch, an attachment angle sensor, a lifting load sensor, a winding amount sensor, a storage unit, and an arithmetic unit. The machine body is a body of a crane. The attachment is attached to the machine body so as to be raisable and lowerable. The winding rope is suspended from the attachment. The hook is suspended from the attachment via the winding rope, and is configured to attach the suspended load. The winding winch winds and unwinds the winding rope. The attachment angle sensor detects a derricking angle of the attachment. The lifting load sensor detects the lifting load acting on the winding rope. The winding amount sensor detects the winding amount of the winding rope by the winding winch. The storage unit stores hoisting height error information, which is information about a hoisting height error associated with magnitude of the derricking angle and magnitude of the lifting load. The arithmetic unit calculates a hoisting height calculation value, which is a calculation value of the hoisting height of the hook based on a derricking angle detection value, which is the derricking angle detected by the attachment angle sensor, and a winding amount detection value, which is the winding amount detected by the winding amount sensor. The hoisting height error is the difference between the hoisting height calculation value and the actual hoisting height of the hook. The arithmetic unit uses the hoisting height error information to determine a hoisting height error corresponding value, which is the hoisting height error corresponding to the derricking angle detection value and a lifting load detection value that is the lifting load detected by the lifting load sensor, and corrects the hoisting height calculation value based on the determined hoisting height error corresponding value.

With the above-described configuration, the information about the hook position can be calculated with high accuracy.

### BRIEF DESCRIPTION OF DRAWINGS

FIG. 1 is a side view showing a crane including a hook position calculation device according to an embodiment.

FIG. 2 is a block diagram of the hook position calculation device shown in FIG. 1.

FIG. 3 is a flowchart showing the process for acquiring a hoisting height error ΔL shown in FIG. 1.

FIG. 4 is a diagram showing hoisting height error information stored in a storage unit shown in FIG. 2.

FIG. 5 is a graph showing the relationship between a derricking angle θ and the hoisting height error ΔL shown in FIG. 1.

FIG. 6 is a flowchart showing the process for reading the hoisting height error ΔL from the storage unit and the process for correcting a hoisting height calculation value Lc.

FIG. 7 is an explanatory diagram of calculation of a working radius R in the crane shown in FIG. 1.

FIG. 8 is a side view showing a crane according to a modification of the embodiment, and the crane includes a jib.

### DESCRIPTION OF EMBODIMENT

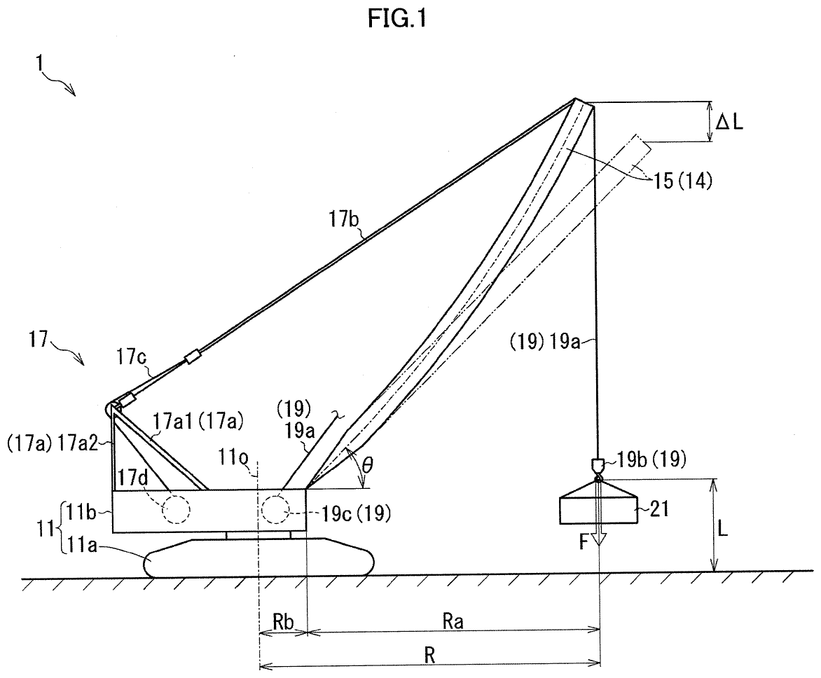

With reference to FIGS. 1 to 8, a crane 1 including a hook position calculation device according to the present embodiment will be described.

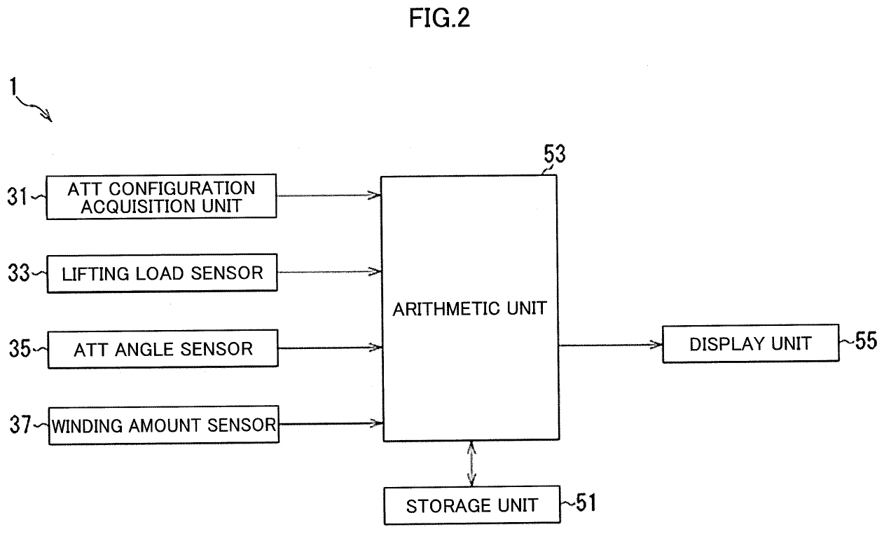

The crane 1 is a machine that performs work using an attachment 14 as shown in FIG. 1. The crane 1 is, for example, a construction machine that performs construction work. The crane 1 includes a machine body 11, the attachment 14, a boom derricking device 17, and a hook winding device 19. As shown in FIG. 2, the crane 1 includes an attachment configuration acquisition unit 31 (ATT configuration acquisition unit in FIG. 2), a lifting load sensor 33, an attachment angle sensor 35 (ATT angle sensor in FIG. 2), and a winding amount sensor 37. The crane 1 includes a storage unit 51, an arithmetic unit 53, and a display unit 55. The crane 1 includes a controller, and the controller includes the arithmetic unit 53 and the storage unit 51. The controller includes a computer.

The machine body 11 is a body part of the crane 1, as shown in FIG. 1. The machine body 11 includes a lower travelling body 11a and an upper slewing body 11b. The lower travelling body 11a causes the crane 1 to travel. The lower travelling body 11a may include crawlers or wheels. The crane 1 may be a crawler crane or a wheel crane. The upper slewing body 11b is slewably mounted on the lower travelling body 11a.

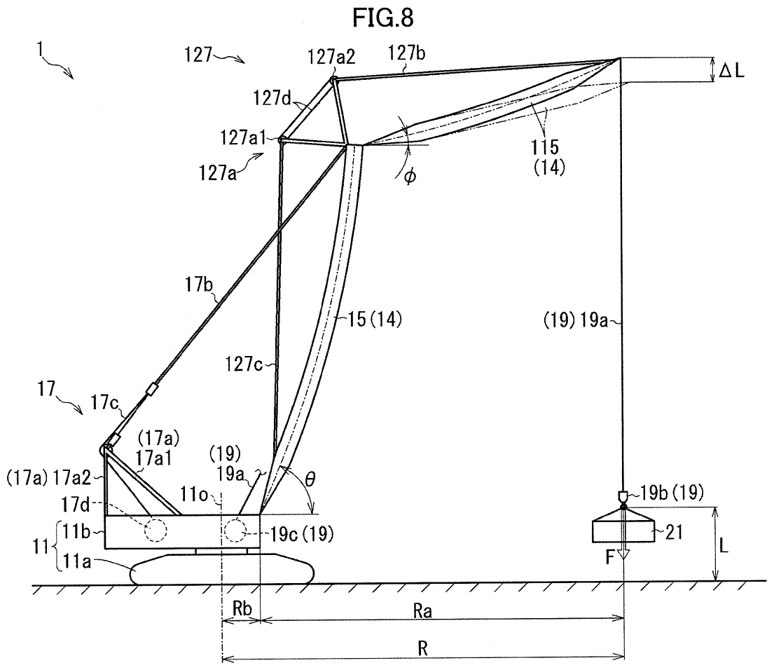

The attachment 14 is attached to the upper slewing body 11b. The attachment 14 is a member that lifts a suspended load 21 via a winding rope 19a and a hook 19b. The attachment 14 includes a boom 15. The boom 15 is a member (derricking member) that is attached to the upper slewing body 11b so as to be raisable and lowerable. For example, the boom 15 may be a lattice boom having a lattice structure, or may be a stretchable boom (not shown) that is stretchable. The attachment 14 may further include a jib 115 (see FIG. 8) (described later).

The boom derricking device 17 is a device that raises and lowers the boom 15 with respect to the upper slewing body 11b. The boom derricking device 17 includes a gantry 17a, a boom guy line 17b, a boom derricking rope 17c, and a boom derricking winch 17d. The gantry 17a includes a compression member 17al and a tension member 17a2. The compression member 17al is attached to the upper slewing body 11b. The tension member 17a2 is connected to the distal end of the compression member 17al (end opposite to the side attached to the upper slewing body 11b) and the rear end of the upper slewing body 11b. The boom guy line 17b and the boom derricking rope 17c are connected to the distal end of the compression member 17al and the distal end of the boom 15 (end opposite to the side attached to the upper slewing body 11b). The boom derricking winch 17d is mounted, for example, in the upper slewing body 11b. When the boom derricking winch 17d winds and unwinds the boom derricking rope 17c, the boom 15 is raised and lowered with respect to the upper slewing body 11b. Note that instead of the gantry 17a, a mast that is attached to the upper slewing body 11b so as to be raisable and lowerable may be provided. When the mast is provided, the mast will be raised and lowered with respect to the upper slewing body 11b, resulting in the boom 15 raised and lowered with respect to the upper slewing body 11b.

The hook winding device 19 is a device that winds up and down the hook 19b. The hook winding device 19 includes the winding rope 19a, the hook 19b, and a winding winch 19c. The winding rope 19a is suspended from the attachment 14 (for example, distal end of the boom 15). The hook 19b is suspended from the attachment 14 (for example, distal end of the boom 15) via the winding rope 19a. The hook 19b is configured to attach the suspended load 21. The winding winch 19c is a winch mounted in the upper slewing body 11b or the boom 15. When the winding winch 19c winds the winding rope 19a, the hook 19b ascends, and when the winding winch 19c unwinds the winding rope 19a, the hook 19b descends.

The attachment configuration acquisition unit 31 (see FIG. 2) acquires attachment configuration information, which is information about the configuration of the attachment 14. For example, the attachment configuration information acquired by the attachment configuration acquisition unit 31 may include information about the length of the boom 15. The attachment configuration information may include information about the length of the jib 115 described later (see FIG. 8), and may also include information about the presence or absence of the jib 115. The attachment configuration acquisition unit 31 may acquire the attachment configuration information manually input by a worker. The attachment configuration acquisition unit 31 may automatically acquire the attachment configuration information from a sensor or the like.

The lifting load sensor 33 (see FIG. 2) detects a lifting load F acting on the winding rope 19a. For example, the lifting load sensor 33 may detect the lifting load F by detecting the load acting on a sheave (not shown) on which the winding rope 19a is hung. The lifting load sensor 33 may detect the lifting load F by detecting the load acting on the winding winch 19c. The lifting load sensor 33 may include, for example, a load cell or the like.

The attachment angle sensor 35 (see FIG. 2) detects a derricking angle θ of the attachment 14. For example, the attachment angle sensor 35 includes a boom angle sensor that detects the derricking angle θ of the boom 15. When the attachment 14 includes the jib 115 (see FIG. 8), the attachment angle sensor 35 may include a jib angle sensor that detects a derricking angle φ of the jib 115. Here, the case where the attachment angle sensor 35 is the boom angle sensor will be mainly described.

The derricking angle θ detected by the attachment angle sensor 35 (derricking angle detection value) is generally an angle between the horizontal direction and the direction in which the central axis of the boom 15 extends. Due to the deflection of the boom 15, the central axis of the boom 15 has a curved shape. Therefore, the derricking angle θ detected by the attachment angle sensor 35 varies depending on the position of the attachment angle sensor 35 or the like. For example, the attachment angle sensor 35 may detect the derricking angle θ by detecting the rotational angle of the boom 15 with respect to the upper slewing body 11b. The attachment angle sensor 35 may detect the derricking angle θ by detecting the inclination angle of the boom 15 with respect to the horizontal surface. The crane 1 may include only one attachment angle sensor 35. For example, the attachment angle sensor 35 may be provided at the proximal end of the boom 15 (end on the side attached to the upper slewing body 11b). The crane 1 may include a plurality of the attachment angle sensors 35. For example, the first attachment angle sensor 35 may be disposed at the proximal end of the boom 15, and the second attachment angle sensor 35 may be disposed at the distal end of the boom 15. In this case, for example, the derricking angle θ of the boom 15 (derricking angle detection value) may be calculated based on the average value of a plurality of detection values detected by the plurality of attachment angle sensors 35.

The winding amount sensor 37 (see FIG. 2) detects the winding amount of the winding rope 19a by the winding winch 19c. The winding amount refers to an amount of the winding rope 19a either wound onto the winding winch 19c or an amount of the winding rope 19a unwound from the winding winch 19c. For example, the winding amount sensor 37 may detect the winding amount by detecting the number of rotations of the winding winch 19c. For example, the winding amount sensor 37 may detect the movement amount of the winding rope 19a by detecting the rotation of a roller that is in contact with the winding rope 19a, and may detect the winding amount based on the movement amount. For example, the winding amount sensor 37 may detect (for example, estimate) the winding amount based on images of the winding rope 19a. In this case, for example, the winding amount sensor 37 may include a camera and an image recognition unit. For example, the camera captures the state of the winding rope 19a wound around a drum of the winding winch 19c. For example, the camera captures images that allow the image recognition unit to recognize the unwinding position of the winding rope 19a and the size of the winding rope 19a wound around the drum. For example, the image recognition unit may estimate the winding amount from the images captured by the camera by using artificial intelligence (AI). Specifically, for example, the image recognition unit may recognize in which layer and which row of the drum of the winding winch 19c the unwinding position of the winding rope 19a is located from the images captured by the camera (the image recognition unit learns in advance to be able to make this recognition). The image recognition unit may recognize the unwinding amount of the winding rope 19a from the winding winch 19c or the winding amount of the winding rope 19a onto the winding winch 19c based on the unwinding position of the winding rope 19a (the image recognition unit learns in advance to be able to make this recognition). Then, the winding amount sensor 37 may estimate the winding amount of the winding rope 19a based on the state of the winding rope 19a recognized by the image recognition unit (estimation of the winding amount is included in the detection of the winding amount).

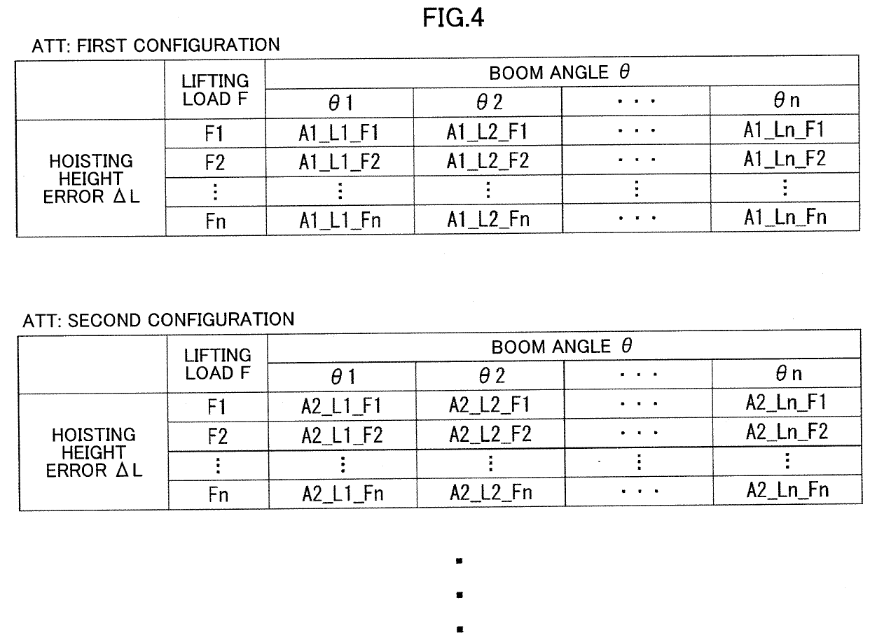

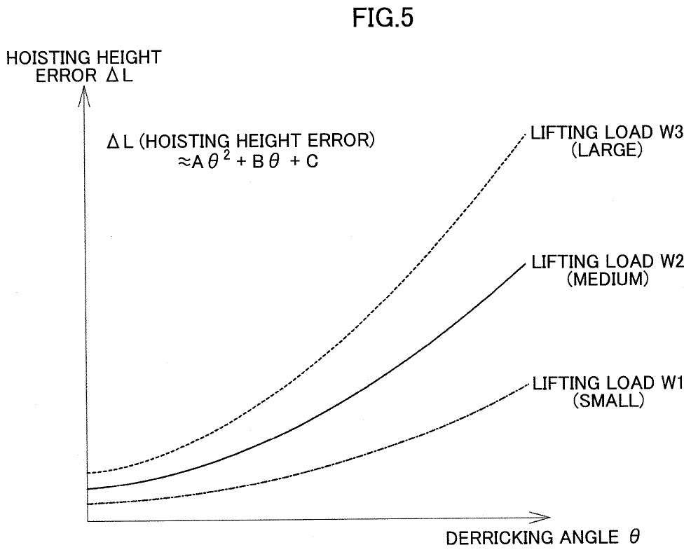

The storage unit 51 (see FIG. 2) stores hoisting height error information, which is information about a hoisting height error ΔL associated with the magnitude of the derricking angle θ of the attachment 14 and the magnitude of the lifting load F. The hoisting height error information may include, for example, as shown in FIG. 4 described later, a plurality of the hoisting height errors ΔL associated with the magnitude of the derricking angle θ of the attachment and the magnitude of the lifting load F. The hoisting height error information may include, for example, a function that represents the relationship between the derricking angle θ and the hoisting height error ΔL, as shown in FIG. 5 described later. The hoisting height error information may include a plurality of functions. The plurality of functions may correspond to a plurality of the lifting loads F of magnitudes different from each other (three lifting loads W1, W2, and W3 in FIG. 5). In this case, each of the plurality of functions is a function that represents the relationship between the derricking angle θ and the hoisting height error ΔL.

The arithmetic unit 53, as shown in FIG. 2, inputs and outputs signals, performs calculations (processing), and the like. For example, to the arithmetic unit 53, the attachment configuration information is input from the attachment configuration acquisition unit 31, and information is input from each of a plurality of sensors, including the lifting load sensor 33, the attachment angle sensor 35, and the winding amount sensor 37. Information about the hoisting height error ΔL (see FIG. 1) may be input from the storage unit 51 to the arithmetic unit 53. The arithmetic unit 53 may cause the storage unit 51 to store information. The arithmetic unit 53 may cause the display unit 55 to display. The arithmetic unit 53 performs calculation of a hoisting height L shown in FIG. 1 (described later) and calculation of a working radius R (described later). The arithmetic unit 53 may output a signal for operating the crane 1 to an actuator (for example, the boom derricking winch 17d and the like). The arithmetic unit 53 may perform automatic driving control of the crane 1. The arithmetic unit 53 may perform control to determine (for example, limit) the area in which the hook 19b can move.

The arithmetic unit 53 calculates a hoisting height calculation value Lc, which is the calculation value of the hoisting height of the hook 19b, based on the derricking angle θ detected by the attachment angle sensor 35 (derricking angle detection value) and the winding amount detected by the winding amount sensor 37 (winding amount detection value). The arithmetic unit 53 determines the hoisting height error ΔL (hoisting height error corresponding value) corresponding to the derricking angle detection value and the lifting load F detected by the lifting load sensor 33 (lifting load detection value) by using the hoisting height error information stored in the storage unit 51. The arithmetic unit 53 corrects the hoisting height calculation value Lc based on the determined hoisting height error corresponding value.

The display unit 55 (see FIG. 2) displays information. The display unit 55 may display the hoisting height L. The display unit 55 may display the working radius R.

### (Operation)

The crane 1 shown in FIG. 1 is configured to operate as follows. Before the crane work is performed by the crane 1 (in advance), the hoisting height error information including a plurality of hoisting height errors ΔL is acquired (acquired in advance). Then, when the crane work is performed by the crane 1, the hoisting height calculation value Lc is corrected based on the hoisting height error information including the plurality of hoisting height errors ΔL acquired in advance. This correction is described after the following paragraph “(Reading of hoisting height error ΔL and correction of hoisting height calculation value Lc)”.

### (Acquisition of Plurality of Hoisting Height Errors ΔL)

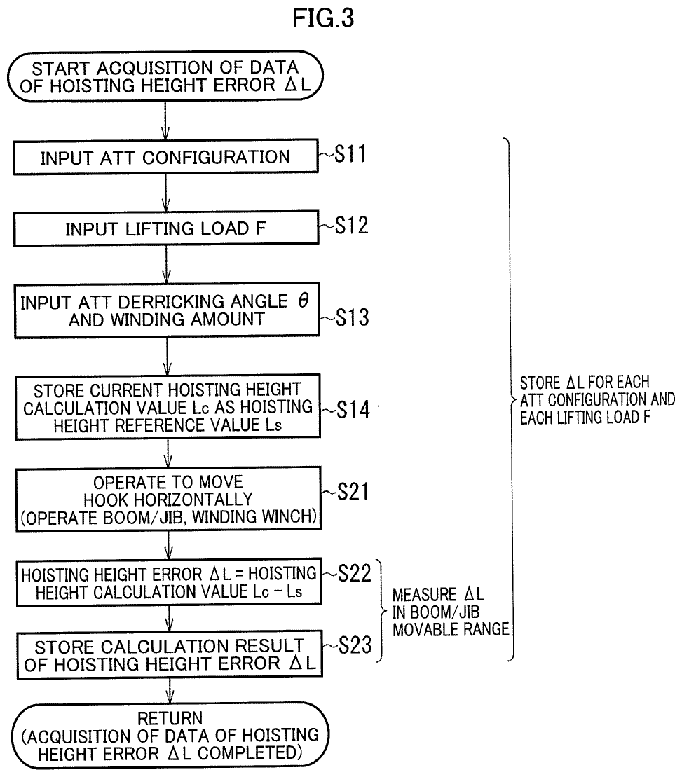

In the crane 1, the storage unit 51 stores the hoisting height error information including the plurality of hoisting height errors ΔL. Each of the plurality of hoisting height errors ΔL is the difference between the hoisting height calculation value Lc, which is the calculation value of the hoisting height L, and the actual hoisting height L of the hook 19b (see step S22 in FIG. 3). The hoisting height L is a value representing the height of the hook 19b as shown in FIG. 1. For example, the hoisting height L may be the height from a reference surface to a specific portion of the hook 19b. The specific portion may be, for example, the upper end of the hook 19b, the lower end of the hook 19b, or another portion of the hook 19b. The “reference surface” may be the bottom surface of the lower travelling body 11a, a surface above or below the bottom surface of the lower travelling body 11a, or the ground.

The hoisting height calculation value Lc is a calculation value of the hoisting height L calculated based on the derricking angle θ of the attachment 14 (for example, the boom 15) and the winding amount of the winding rope 19a. For example, the controller may set the state of the crane 1 when input to an input device (for example, button (not shown)) for resetting the reference about the hoisting height L is made by, for example, a worker to “reference state.” The controller sets the hoisting height L in this reference state to a hoisting height reference value Ls (see step S14 in FIG. 3). The hoisting height reference value Ls may be set to, for example, zero, or may be set to some other value. When the derricking angle θ of the boom 15 changes from the reference state, the arithmetic unit 53 calculates the hoisting height L after the derricking angle θ changes based on the amount of change in the derricking angle θ. When the winding amount of the winding rope 19a changes from the reference state, the arithmetic unit 53 calculates the hoisting height L after the change in the winding amount based on the amount of change in the winding amount. In this way, the hoisting height L calculated based on the amount of change in the derricking angle θ of the boom 15 from the reference state, and the amount of change in the winding amount of the winding rope 19a from the reference state is the hoisting height calculation value Lc.

An error occurs in the hoisting height calculation value Lc with respect to the actual hoisting height L. Details of this error are as follows, for example.

[Example A1] An error occurs between the hoisting height calculation value Lc and the actual hoisting height L due to the deflection of the attachment 14 (boom 15 in the present embodiment). The deflection amount of the boom 15 varies depending on the lifting load F and the derricking angle θ of the boom 15. Therefore, this error varies depending on the lifting load F and the derricking angle θ.

[Example A2] An error occurs between the hoisting height calculation value Lc and the actual hoisting height L due to the slack in the winding rope 19a.

[Example A2-1] The slack amount of the winding rope 19a varies depending on the lifting load F. Therefore, this error varies depending on the lifting load F.

[Example A2-2] The slack amount of the winding rope 19a varies depending on the winding amount of the winding rope 19a. Specifically, when the unwinding amount of the winding rope 19a from the winding winch 19c is small, the influence of the stretch of the winding rope 19a (slack amount) will be small, and when the unwinding amount of the winding rope 19a is large, the influence of the stretch of the winding rope 19a will be large accordingly. Therefore, an error between the hoisting height calculation value Lc and the actual hoisting height L varies depending on the winding amount of the winding rope 19a.

The slack amount of the winding rope 19a also varies depending on conditions other than those mentioned above (conditions other than the lifting load F and the winding amount of the winding rope 19a). For example, the slack amount of the winding rope 19a varies depending on the influence of the sheave on which the winding rope 19a is hung. Specifically, for example, the slack amount of the winding rope 19a varies depending on magnitude of pulling force of the winding winch 19c that is determined by the sheave efficiency of the sheave on which the winding rope 19a is hung (pulling force=lifting load F/sheave efficiency). For example, the slack amount of the winding rope 19a varies depending on the quantity (number) of sheaves on which the winding rope 19a is hung. In more detail, if there are many sheaves on which the winding rope 19a is hung, the winding rope 19a will slack, and the amount of winding down the hook 19b will be smaller than the amount of the winding rope 19a unwound from the winding winch 19c (the amount unwound from the winding winch 19c is not conveyed as it is). For example, the slack amount of the winding rope 19a varies depending on the type of rope (material, thickness, and the like). For example, the slack amount of the winding rope 19a varies due to the influences of local stretch caused by secular changes in the winding rope 19a. In a state where the winding rope 19a slacks due to these influences (influence of sheave, rope type, and secular changes) (in a state where these influences are taken into account), the hoisting height error ΔL is acquired.

The hoisting height error ΔL is the sum of the error caused by the deflection of the boom 15 (above [Example A1]) and the error caused by the slack in the winding rope 19a (above [Example A2]). Note that since the error in the above [Example A2-2] is smaller than the error in the above [Example A1] and [Example A2-1], the error due to the above [Example A2-2] does not need to be taken into account.

The storage unit 51 stores, as the hoisting height error information, the plurality of hoisting height errors ΔL associated with the magnitude of the derricking angle θ of the attachment and the magnitude of the lifting load F. For example, the storage unit 51 may store the hoisting height error ΔL associated with each of a plurality of combinations that can be created using the plurality of derricking θ angles different from each other and the plurality of lifting loads F different from each other. Each of the plurality of combinations may be a combination of any one of the plurality of derricking angles θ and any one of the plurality of lifting loads F. Specifically, the plurality of hoisting height errors ΔL may be stored in the storage unit 51 (see FIG. 2), for example, as in the following [Example B1].

[Example B1] The hoisting height error ΔL may be stored in the storage unit 51 for each of the plurality of derricking angles θ of the boom 15 and for each of the plurality of magnitudes of the lifting load F. Specifically, for example, as shown in FIG. 4, for each of various derricking angles θ (θ1, θ2, . . . θn) when the lifting load F is F1, the hoisting height error ΔL is stored in the storage unit 51 (see FIG. 2). For each of various derricking angles θ (θ1, θ2, . . . θn) when the lifting load F is F2 different from F1, the hoisting height error ΔL is stored in the storage unit 51. The boom angle θ in FIG. 4 is one example of the derricking angle of the attachment. Similarly, for each of various lifting loads F (F1, F2, . . . . Fn) when the derricking angle θ is θ1, the hoisting height error ΔL is stored in the storage unit 51. For each of various lifting loads F (F1, F2, . . . . Fn) when the derricking angle θ is θ2 different from θ1, the hoisting height error ΔL is stored in the storage unit 51. That is, for each of the plurality of lifting loads F, the plurality of hoisting height errors ΔL associated with the plurality of derricking angles θ is stored in the storage unit 51.

The hoisting height error information is preferably information about the hoisting height error ΔL associated with the magnitude of the derricking angle θ, the magnitude of the lifting load F, and the configuration of the attachment. The storage unit 51 preferably stores, as the hoisting height error information, the plurality of hoisting height errors ΔL associated with the magnitude of the derricking angle θ of the attachment, the magnitude of the lifting load F, and the configuration of the attachment.

For example, the storage unit 51 may store the hoisting height error ΔL associated with each of a plurality of combinations that can be created using the plurality of derricking angles θ different from each other, the plurality of lifting loads F different from each other, and the plurality of configurations of the attachment 14 different from each other. Each of the plurality of combinations may be a combination of any one of the plurality of derricking angles θ, any one of the plurality of lifting loads F, and any one of the plurality of configurations. The plurality of configurations of the attachment 14 in the hoisting height error information includes a first configuration and a second configuration. The first configuration includes at least one first configuration content, the second configuration includes at least one second configuration content, and the first configuration content and the second configuration content are different from each other. For example, each of the first configuration content and the second configuration content may be the length of the boom 15. Each of the first configuration content and the second configuration content may be the length of the jib 115 (see FIG. 8). Each of the first configuration content and the second configuration content may be information about the presence or absence of the jib 115. Specifically, the plurality of hoisting height errors ΔL may be stored in the storage unit 51, for example, as in the following [Example B2].

[Example B2] In the specific example shown in FIG. 1, the plurality of configurations of the attachment 14 includes the first configuration and the second configuration. The first configuration may include the first configuration content in which the length of the boom 15 is a first length. The second configuration may include the second configuration content in which the length of the boom 15 is a second length different from the first length. In the specific examples shown in FIGS. 1 and 8, the plurality of configurations of the attachment 14 may include the first configuration and the second configuration, the first configuration may include the first configuration content including the boom 15, and the second configuration may include the second configuration content including the boom 15 and the jib 115. In this case, the first configuration may include the first configuration content including the boom 15 having a first boom length, and the second configuration may include the second configuration content including the boom 15 having a second boom length and the jib 115 having a second jib length.

The hoisting height error information stored in the storage unit 51 includes first information and second information. Specifically, for example, the first information may be information shown in the upper table in FIG. 4, and the second information may be information shown in the lower table in FIG. 4. The first information is information associated with the first configuration among the plurality of configurations of the attachment 14, and the second information is information associated with the second configuration among the plurality of configurations of the attachment 14. Specifically, for example, as shown in the upper table in FIG. 4, when the configuration of the attachment 14 is the first configuration, the plurality of hoisting height errors ΔL associated with the plurality of derricking angles θ (θ1, θ2, . . . θn) for each of the plurality of lifting loads F (F1, F2, . . . . Fn) may be stored in the storage unit 51. As shown in the lower table in FIG. 4, when the configuration of the attachment 14 is the second configuration different from the first configuration, the plurality of hoisting height errors ΔL associated with the plurality of derricking angles θ for each of the plurality of lifting loads F may be stored in the storage unit 51. That is, for each of the plurality of configurations of the attachment 14, the hoisting height error ΔL associated with each of the plurality of combinations that can be made using the plurality of derricking angles θ and the plurality of lifting loads F may be stored in the storage unit 51.

[Example B3] Note that for each of various winding amounts of the winding rope 19a shown in FIG. 1, the plurality of hoisting height errors ΔL corresponding to various derricking angles θ may be stored in the storage unit 51 (see FIG. 2) (see the above [Example A2-2]).

A specific example of the procedure for acquiring the hoisting height error ΔL. (procedure stored in the storage unit 51) is as follows.

[Example C1] For example, the boom 15 is disposed at a certain derricking angle θ and the winding rope 19a is adjusted to a certain winding amount. In this state, the hoisting height calculation value Lc is calculated. From this state, the lifting load F is changed to various magnitudes without changing the derricking angle θ and the winding amount. Specifically, for example, the weight attached to the hook 19b (corresponding to the suspended load 21) is replaced with these having various masses. In this case, the hoisting height L at each lifting load F is measured. The difference between the measured hoisting height L and the hoisting height calculation value Lc may be calculated as the hoisting height error ΔL, and the calculated hoisting height error ΔL may be stored in the storage unit 51. Using the above procedure, the storage unit 51 may store the plurality of hoisting height errors ΔL associated with the magnitude of the derricking angle θ of the attachment and the magnitude of the lifting load F.

[Example C2] For example, without changing the lifting load F, at least any one of the derricking angle θ and the winding amount of the winding rope 19a is changed to various magnitudes. In this case, the hoisting height L at each magnitude is measured. Then, the difference between the measured hoisting height L and the hoisting height calculation value Lc may be calculated as the hoisting height error ΔL, and the calculated hoisting height error ΔL may be stored in the storage unit 51. Using the above procedure, the storage unit 51 may store the plurality of hoisting height errors ΔL associated with the magnitude of the derricking angle θ of the attachment and/or the winding amount of the winding rope 19a, and the magnitude of the lifting load F.

[Example C2-1] For example, without changing the lifting load F, the derricking angle θ is changed to various magnitudes. At this time, the hoisting height L is measured while the winding rope 19a is wound up or down such that the hoisting height calculation value Lc remains constant. Then, the difference between the measured hoisting height L and the hoisting height calculation value Lc may be calculated as the hoisting height error ΔL, and the calculated hoisting height error ΔL may be stored in the storage unit 51. Using the above procedure, the storage unit 51 may store the plurality of hoisting height errors ΔL associated with the magnitude of the derricking angle θ of the attachment and the magnitude of the lifting load F.

[Example C2-2] For example, without changing the lifting load F, the derricking angle θ is changed to various magnitudes. At this time, the winding rope 19a is wound up or down such that the actual measurement value of the hoisting height L remains constant (that is, the hook 19b moves horizontally) (described later). Then, the difference between the hoisting height calculation value Lc calculated based on the derricking angle θ and the winding amount of the winding rope 19a, and the actual measurement value of the hoisting height L may be calculated as the hoisting height error ΔL, and the calculated hoisting height error ΔL may be stored in the storage unit 51. Using the above procedure, the storage unit 51 may store the plurality of hoisting height errors ΔL associated with the magnitude of the derricking angle θ of the attachment and the magnitude of the lifting load F.

A specific example of this [Example C2-2] will be described below with reference to the flowchart shown in FIG. 3.

### (Specific Example of Acquisition of Hoisting Height Error ΔL)

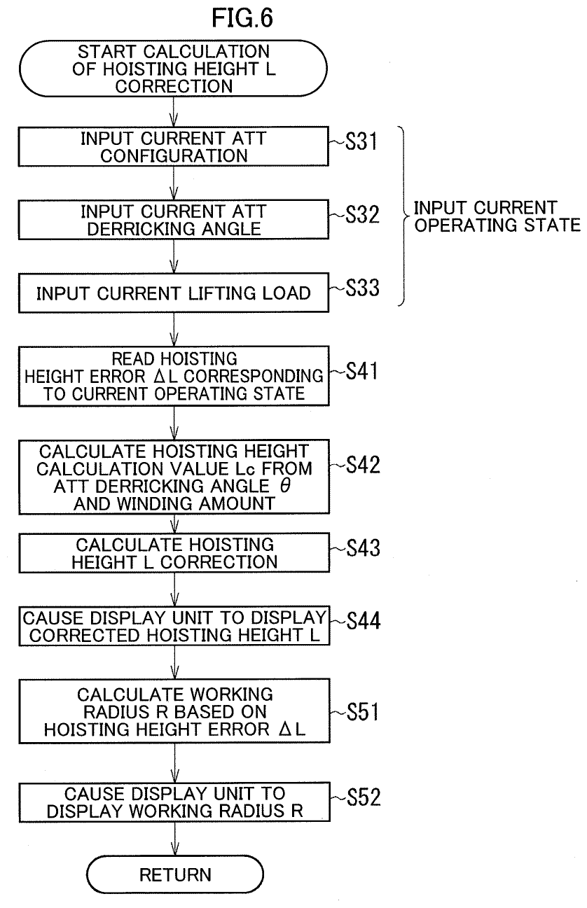

In step S11, the configuration of the attachment 14 shown in FIG. 1 is input to the arithmetic unit 53 (see FIG. 2). For example, the configuration of the attachment 14 input to the arithmetic unit 53 may be information acquired by the attachment configuration acquisition unit 31 (see FIG. 2), or may not be information acquired by the attachment configuration acquisition unit 31. Note that in FIG. 3, the attachment 14 is described as “ATT” (the same applies to FIG. 6).

In step S12, the lifting load F is input to the arithmetic unit 53. For example, the lifting load F input to the arithmetic unit 53 may be a value automatically acquired, for example, a value detected by the lifting load sensor 33 (see FIG. 2) or the like, or may be a value manually input by a worker.

In this way, in “Acquisition of hoisting height error ΔL”, various sensors may be used. The sensor that can be used for the “Acquisition of hoisting height error ΔL” is preferably a common sensor to the sensor used for “Reading of hoisting height error ΔL and correction of hoisting height calculation value Lc” as described later, but may not be the common sensor. Specifically, the lifting load sensor 33, the attachment angle sensor 35, and the winding amount sensor 37 shown in FIG. 2 are sensors used at least for “Reading of hoisting height error ΔL and correction of hoisting height calculation value Lc”, but these sensors may also be used for “Acquisition of hoisting height error ΔL”, and may not be used.

In step S13, the derricking angle θ of the attachment 14 shown in FIG. 1 (boom 15 in the present embodiment) and the winding amount of the winding rope 19a are input to the arithmetic unit 53. For example, the derricking angle θ input to the arithmetic unit 53 may be a value detected by the attachment angle sensor 35 or may not be a value detected by the attachment angle sensor 35. For example, the winding amount input to the arithmetic unit 53 may be a value detected by the winding amount sensor 37 or may not be a value detected by the winding amount sensor 37.

In step S14, the current hoisting height calculation value Lc is stored in the storage unit 51 as the hoisting height reference value Ls. In more detail, the arithmetic unit 53 calculates the current hoisting height calculation value Lc based on the current derricking angle θ of the attachment 14 and the winding amount of the winding rope 19a. The arithmetic unit 53 stores the calculated hoisting height calculation value Lc as the hoisting height reference value Ls in the storage unit 51.

In step S21, the attachment 14 and the winding winch 19c are operated such that the hook 19b moves horizontally (that is, such that the actual hoisting height L is maintained constant). Specifically, the derricking of the boom 15 and the winding up or down of the winding rope 19a are performed. For example, when the hook 19b is brought closer to the upper slewing body 11b (when horizontal pulling is performed), the winding rope 19a is wound down while the boom 15 is raised. When the hook 19b is moved away from the upper slewing body 11b, the winding rope 19a is wound up while the boom 15 is lowered. Note that when the attachment 14 includes the jib 115 (see FIG. 8), the derricking of the jib 115 and the winding up or down of the winding rope 19a are performed. The operation to operate the attachment 14 and the winding winch 19c may be performed manually or automatically. In more detail, the operator may manually operate the attachment 14 and the winding winch 19c such that the hook 19b moves horizontally. For example, a sensor installed outside the crane 1 may detect the hoisting height L, and the attachment 14 and the winding winch 19c may be automatically operated such that the detected actual hoisting height L remains constant. The “sensor installed outside the crane 1” for detecting the hoisting height L may be, for example, a camera, or, for example, a non-contact sensor using light (specifically, laser light or the like) or electromagnetic waves.

In step S22, the hoisting height error ΔL is calculated by the arithmetic unit 53. In more detail, the arithmetic unit 53 calculates the hoisting height calculation value Lc at a plurality of positions when the hook 19b is horizontally moved based on the derricking angle θ of the attachment 14 and the winding amount of the winding rope 19a. Then, the arithmetic unit 53 calculates the difference between each of the plurality of hoisting height calculation values Lc calculated at the plurality of positions when the hook 19b is horizontally moved and the hoisting height reference value Ls (that is, hoisting height error ΔL).

In this example, the hoisting height error ΔL that takes into account the deflection of the attachment 14 and the slack of the winding rope 19a can be acquired. In more detail, when the hoisting height reference value Ls is acquired (in step S14), the attachment 14 has deflection and the winding rope 19a has slack. From this state, the derricking angle θ of the attachment 14 and the winding amount of the winding rope 19a are changed. Here, in the above example, when the derricking angle θ and the winding amount are changed, the hook 19b is horizontally moved. Therefore, if there is no change in the deflection amount of the attachment 14 and there is no change in the slack amount of the winding rope 19a, the hoisting height calculation value Lc when the hook 19b moves horizontally should not change from the hoisting height reference value Ls. Meanwhile, in reality, since there is a change in the deflection amount of the attachment 14 and there is a change in the slack amount of the winding rope 19a, when the hook 19b moves horizontally, the hoisting height calculation value Lc changes and deviates from the hoisting height reference value Ls. By subtracting the hoisting height reference value Ls from the hoisting height calculation value Lc, the hoisting height error ΔL that takes into account the deflection of the attachment 14 and the slack of the winding rope 19a is calculated.

In step S23, the calculated hoisting height error ΔL is stored in the storage unit 51. For example, in the entire or almost entire movable range of the attachment 14, while the attachment 14 is raised and lowered, the hoisting height error ΔL is calculated and stored. Next, the flow returns to step S11. Then, the lifting load F is changed, and the hoisting height error ΔL is stored in the storage unit 51, as described above. The configuration of the attachment 14 is changed, and the hoisting height error ΔL is stored in the storage unit 51 as described above. This allows the storage unit 51 to store the plurality of hoisting height errors ΔL associated with the magnitude of the derricking angle of the attachment, the magnitude of the lifting load, and the configuration of the attachment 14.

### (Another Specific Example of Storage of Hoisting Height Error ΔL)

The storage unit 51 may store, for example, the hoisting height error information about the hoisting height error ΔL as described next.

[Example D1] When the hoisting height error ΔL is continuously acquired while the derricking angle θ is continuously changed, the storage unit 51 may store the relationship between the continuously changing derricking angle θ and the continuously changing hoisting height error ΔL (see, for example, the graph shown in FIG. 5).

[Example D2] When the hoisting height error ΔL is acquired discontinuously (intermittently) while the derricking angle θ shown in FIG. 1 is changed, the storage unit 51 may store the relationship between the discontinuously acquired derricking angle θ and the discontinuously acquired hoisting height error ΔL.

[Example D3] The storage unit 51 may store a formula (described later) derived based on the relationship between the derricking angle θ and the hoisting height error ΔL.

[Example D4] The storage unit 51 may store the value of the hoisting height error ΔL calculated from the formula derived based on data of the discontinuous hoisting height error ΔL.

The formulas in the above [Example D3] and [Example D4] may be, for example, functions with the derricking angle θ as a variable (for example, quadratic functions or the like) (see graph in FIG. 5). Specifically, for example, the hoisting height error ΔL is expressed by the following formula 1.

$$Δ L = a {θ}^{2} + b θ + c \qquad ( Formula 1 )$$

Here, a, b, and c are constants. Formula 1 is calculated for each of various lifting loads F. In the example shown in FIG. 5, a function with the derricking angle θ as a variable is set for each of the three types of lifting loads F (W1 (small), W2 (medium), W3 (large)).

### (Reading of Hoisting Height Error ΔL and Correction of Hoisting Height Calculation Value Lc)

The hoisting height error ΔL described above is acquired (in advance) before the crane work is performed in the crane 1. During the work in the crane 1, the hoisting height calculation value Lc is corrected based on the hoisting height error information about the hoisting height error ΔL. In more detail, during the crane work performed in the crane 1, the current state (current operating state) of the crane 1 is input to the arithmetic unit 53 (see FIG. 2). Specifically, the derricking angle θ detected by the attachment angle sensor 35 (current derricking angle θ) and the lifting load F detected by the lifting load sensor 33 (current lifting load F) are input to the arithmetic unit 53.

The arithmetic unit 53 (see FIG. 2) reads the hoisting height error ΔL (hoisting height error corresponding value) corresponding to the current derricking angle θ and the current lifting load F from the storage unit 51.

[Example E1] For example, the arithmetic unit 53 may select the hoisting height error ΔL that aligns with or is closest to the current derricking angle θ and current lifting load F from among the plurality of hoisting height errors ΔL included in the hoisting height error information shown in FIG. 4.

[Example E2] The arithmetic unit 53 may read the formula about the hoisting height error ΔL (for example, above formula 1) from the storage unit 51 and calculate the hoisting height error ΔL corresponding to the current derricking angle θ and the current lifting load F by using this formula.

[Example E3] The arithmetic unit 53 may read, from the storage unit 51, the calculation result of the hoisting height error ΔL corresponding to the current derricking angle θ and the current lifting load F, the calculation result being previously calculated from the above formula. Note that the processes of above [Example E2] and [Example E3] are also included in “the arithmetic unit 53 reads the hoisting height error ΔL from the storage unit 51.”

As shown in the upper and lower tables in FIG. 4, when the plurality of hoisting height errors ΔL is stored in the storage unit 51 for each of the plurality of configurations of the attachment 14, the current configuration of the attachment 14 acquired by the attachment configuration acquisition unit 31 is input to the arithmetic unit 53 (see FIG. 2). When the current configuration of the attachment 14 is the first configuration, the arithmetic unit 53 reads the hoisting height error ΔL corresponding to the current derricking angle θ and the current lifting load F from the first information shown in the upper table stored in the storage unit 51. Similarly, when the current configuration of the attachment 14 is the second configuration, the arithmetic unit 53 reads the hoisting height error ΔL corresponding to the current derricking angle θ and the current lifting load F from the second information shown in the lower table stored in the storage unit 51.

Note that as described above, the hoisting height error ΔL may be stored in the storage unit 51 (see FIG. 2) for each of the plurality of (various) winding amounts of the winding rope 19a. In this case, the arithmetic unit 53 reads the hoisting height error ΔL corresponding to the winding amount detected by the winding amount sensor 37 (current winding amount), the current derricking angle θ, and the current lifting load F from the storage unit 51. The arithmetic unit 53 may read the hoisting height error ΔL corresponding to the current configuration of the attachment 14, the current winding amount, the current derricking angle θ, and the current lifting load F from the storage unit 51.

Based on the hoisting height error ΔL read from the storage unit 51, the arithmetic unit 53 corrects the hoisting height calculation value Lc calculated based on the current derricking angle θ and the current winding amount. For example, the arithmetic unit 53 may define the sum of the hoisting height calculation value Lc and the hoisting height error ΔL as the corrected hoisting height L.

### (Specific Example of Reading of Hoisting Height Error ΔL and Correction of Hoisting Height Calculation Value Lc)

A specific example of reading of the hoisting height error ΔL and correction of the hoisting height calculation value Lc will be described with reference to the flowchart shown in FIG. 6.

In steps S31 to S33, the current operating state of the crane 1 shown in FIG. 1 is input to the arithmetic unit 53. In more detail, in step S31, the attachment configuration information acquired by the attachment configuration acquisition unit 31, which is information about the current configuration of the attachment 14, is input to the arithmetic unit 53. In step S32, the current derricking angle θ of the attachment 14 acquired by the attachment angle sensor 35 is input to the arithmetic unit 53. In step S33, the current lifting load F acquired by the lifting load sensor 33 is input to the arithmetic unit 53.

In step S41, the arithmetic unit 53 reads the hoisting height error ΔL corresponding to the current operating state from the storage unit 51. In more detail, the arithmetic unit 53 reads the hoisting height error ΔL (hoisting height error corresponding value) corresponding to the current configuration of the attachment 14, the current derricking angle θ of the attachment 14, and the current lifting load F from the hoisting height error information stored in the storage unit 51. The arithmetic unit 53 may calculate the hoisting height error corresponding value by using, for example, the above formula (Formula 1).

In step S43, the arithmetic unit 53 corrects the hoisting height calculation value Lc by using the hoisting height error ΔL. In more detail, the arithmetic unit 53 calculates the hoisting height calculation value Lc based on the current derricking angle θ and the current winding amount. The arithmetic unit 53 corrects the hoisting height calculation value Lc, for example, by adding or subtracting the hoisting height error ΔL (hoisting height error corresponding value) read in step S41 to or from the hoisting height calculation value Lc, and obtains the corrected hoisting height L.

In step S44, the arithmetic unit 53 causes the display unit 55 to display the corrected hoisting height L (see FIG. 2). The arithmetic unit 53 may perform automatic driving of the crane 1 by using the corrected hoisting height L.

### (Calculation of Working Radius R)

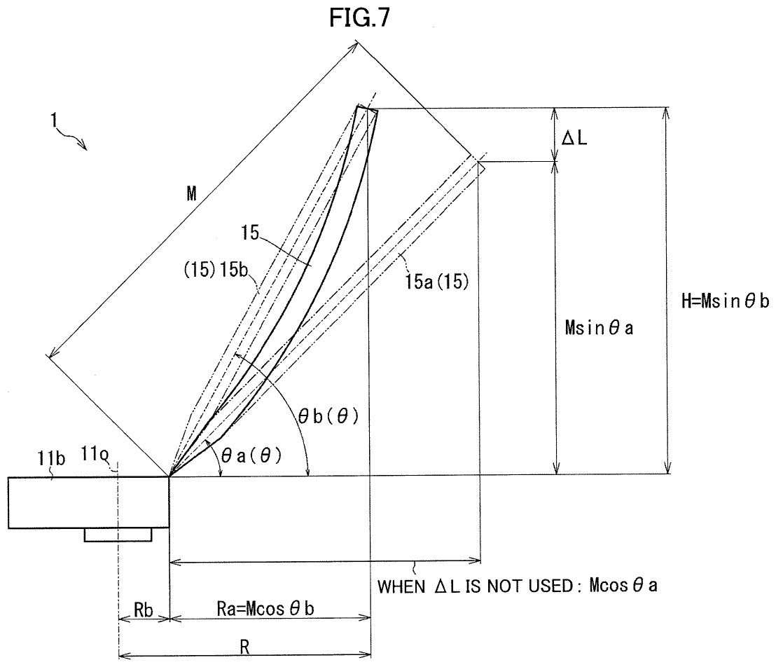

The arithmetic unit 53 may calculate the working radius R by using the hoisting height error ΔL. The working radius R is the horizontal distance (distance in the horizontal direction) from the slewing center 110 of the upper slewing body 11b with respect to the lower travelling body 11a to the hook 19b. In the example shown in FIG. 1, the working radius R is the sum of the horizontal distance from the proximal end of the boom 15 to the hook 19b (first distance Ra), and the horizontal distance from the slewing center 11o to the proximal end of the boom 15 (second distance Rb). For example, in cases such as where the boom 15 is a stretchable boom (not shown), when the proximal end of the boom 15 is disposed behind the slewing center 110 in the upper slewing body 11b, the working radius R is the first distance Ra minus the second distance Rb. The second distance Rb is a constant and is set (in advance) in the arithmetic unit 53 before the calculation of the working radius R is performed. The arithmetic unit 53 calculates the first distance Ra. In more detail, the arithmetic unit 53 reads the hoisting height error ΔL from the storage unit 51 (see FIG. 2). Then, the arithmetic unit 53 calculates the first distance Ra based on the hoisting height error ΔL, the derricking angle θ detected by the attachment angle sensor 35 (current derricking angle θ), and the length of the attachment 14 (for example, the length M of the boom 15 shown in FIG. 7). The arithmetic unit 53 calculates the working radius R based on the calculated first distance Ra and the second distance Rb (constant) (step S51). The arithmetic unit 53 causes the display unit 55 to display the calculated working radius R (step S52). The arithmetic unit 53 may cause the display unit 55 to display the first distance Ra. The arithmetic unit 53 may use the calculated working radius R (or first distance Ra) to perform automatic driving of the crane 1.

### (Specific Example of Calculation of Working Radius R)

Specifically, for example, the arithmetic unit 53 calculates the working radius R as follows. The derricking angle θ detected by the attachment angle sensor 35 (current derricking angle θ) is defined as a derricking angle Ga as shown in 7. Here, the state in which the boom 15 has the derricking angle θa and has no deflection (or as little deflection as possible) is defined as the reference state (see the boom 15a shown in FIG. 7). Then, the hoisting height error ΔL in the current operating state is determined based on the current configuration of the attachment 14, current derricking angle θa, and current lifting load F (see FIG. 1).

The length of the boom 15 (in more detail, the length of the boom 15 in the longitudinal direction of the boom 15) is defined as length M. The length M may be the straight-line distance from the proximal end to the distal end of the boom 15 when the boom 15 is in an undeflected state. The length M may be the length of the boom 15 taking the deflection into account. For example, the length M may be the straight-line distance from the proximal end to the distal end of the actual boom 15 when the derricking angle θ of the boom 15 is a predetermined angle and the lifting load F is a predetermined magnitude.

The height H from the proximal end to the distal end of the boom 15 in the current operating state is expressed by the following formula 2.

$$H = M sin θ a + Δ L \qquad ( Formula 2 )$$

Note that since the boom 15a in the reference state is actually deflected, the height H does not strictly align with “M sin θa+ΔL”, but substantially aligns.

Consider a virtual boom 15b with no deflection. It is assumed that the position of the distal end in the virtual boom 15b is the same as the position of the distal end in the actual boom 15 with deflection. The derricking angle θ of the virtual boom 15b is defined as a derricking angle θb. At this time, the height H of the boom 15b is expressed by the following formula 3.

$$H = M sin θ b \qquad ( Formula 3 )$$

From formula 2 and formula 3, the following formula 4 holds.

$$M sin θ b = M sin θ a + Δ L \qquad ( Formula 4 )$$

Therefore, the following formula 5 holds.

$$θ b = {sin}^{- 1} ( ( M sin θ a + Δ L ) / M ) \qquad ( Formula 5 )$$

The first distance Ra is expressed as M cos σb by using θb. Therefore, the working radius R is expressed as “M cos σb+Rb”.

### Effect of First Invention

The effect of the crane 1 including the hook position calculation device according to the present embodiment is as follows. The crane 1 includes the machine body 11, the attachment 14, the winding rope 19a, the hook 19b, the winding winch 19c, the attachment angle sensor 35 shown in FIG. 2, the lifting load sensor 33, the winding amount sensor 37, the storage unit 51, and the arithmetic unit 53. As shown in FIG. 1, the attachment 14 is attached to the machine body 11 so as to be raisable and lowerable. The winding rope 19a is suspended from the attachment 14. The hook 19b is suspended from the attachment 14 via the winding rope 19a, and is configured to attach the suspended load 21. The winding winch 19c winds and unwinds the winding rope 19a. The attachment angle sensor 35 (see FIG. 2) detects a derricking angle θ of the attachment 14. The lifting load sensor 33 (see FIG. 2) detects a lifting load F acting on the winding rope 19a. The winding amount sensor 37 (see FIG. 2) detects the winding amount of the winding rope 19a by the winding winch 19c.

[Configuration 1] The storage unit 51 (see FIG. 2) stores the hoisting height error ΔL for each of the plurality of derricking angles θ of the attachment 14 and each of the plurality of magnitudes of the lifting load F (see FIG. 3). The hoisting height error ΔL is the difference between the hoisting height calculation value Lc (see FIG. 3) and the actual hoisting height L of the hook 19b. The hoisting height calculation value Lc is the hoisting height L of the hook 19b calculated based on the derricking angle θ of the attachment 14 and the winding amount of the winding rope 19a. The arithmetic unit 53 (see FIG. 2) reads the hoisting height error ΔL corresponding to the derricking angle θ detected by the attachment angle sensor 35 and the lifting load F detected by the lifting load sensor 33 from the storage unit 51 (see step S41 in FIG. 6). Based on the hoisting height error ΔL read from the storage unit 51, the arithmetic unit 53 corrects the hoisting height calculation value Lc calculated based on the derricking angle θ detected by the attachment angle sensor 35 and the winding amount detected by the winding amount sensor 37 (see steps S32 to S43 in FIG. 6).

The following effect is obtained from the above [Configuration 1]. When at least one of the derricking angle θ of the attachment 14 and the lifting load F changes, at least one of the deflection amount of the attachment 14 and the slack amount of the winding rope 19a changes. Therefore, the hoisting height calculation value Lc calculated based on the derricking angle θ of the attachment 14 and the winding amount of the winding rope 19a (see FIG. 3) deviates from the actual hoisting height L. Therefore, the crane 1 has the above [Configuration 1]. Therefore, the hoisting height calculation value Lc is corrected using the hoisting height error ΔL corresponding to the derricking angle θ detected by the attachment angle sensor 35 (current derricking angle θ) and the lifting load F detected by the lifting load sensor 33 (current lifting load F). Therefore, information about the position of the hook 19b (specifically, hoisting height L) can be calculated with high accuracy. As a result, when control using the information about the position of the hook 19b (hoisting height L) is performed (for example, automatic driving of the crane 1 or the like), the accuracy of the control can be improved.

### Effect of Second Invention

[Configuration 2] The crane 1 includes the attachment configuration acquisition unit 31 (see FIG. 2) that acquires the configuration of the attachment 14. The storage unit 51 stores the hoisting height error ΔL for each of the plurality of configurations of the attachment 14 (see FIG. 4). The hoisting height error ΔL the arithmetic unit 53 reads from the storage unit 51 is as follows. The hoisting height error ΔL is the hoisting height error ΔL corresponding to the configuration of the attachment 14 acquired by the attachment configuration acquisition unit 31, the derricking angle θ detected by the attachment angle sensor 35, and the lifting load F detected by the lifting load sensor 33.

The following effects can be obtained by the above [Configuration 2]. In the crane 1, the configuration of the attachment 14 (for example, the length of the boom 15, the presence or absence and length of the jib 115 (see FIG. 8), or the like) may be changed. Therefore, in the above [Configuration 2], the hoisting height error ΔL is stored for each of the plurality of configurations of the attachment 14 (see FIG. 4), and the hoisting height error ΔL corresponding to the configuration of the attachment 14 is read into the arithmetic unit 53 (see steps S31 and S41 in FIG. 6). Therefore, it is possible to correct the hoisting height calculation value Lc by using the hoisting height error ΔL corresponding to the configuration of the attachment 14.

### Effect of Third Invention

[Configuration 3] The arithmetic unit 53 calculates the first distance Ra based on the hoisting height error ΔL read from the storage unit 51, the derricking angle θ detected by the attachment angle sensor 35, and the length M of the attachment 14 (see FIG. 7). The first distance Ra is the horizontal distance from the proximal end of the attachment 14 to the hook 19b.

In the above [Configuration 3], the hoisting height error ΔL is used to calculate the first distance Ra. Therefore, information about the position of the hook 19b (specifically, first distance Ra) can be calculated with high accuracy, better than when the hoisting height error ΔL is not used, for example, when the first distance Ra is calculated based only on the hoisting height calculation value Lc. As a result, when control using the information about the position of the hook 19b is performed (for example, automatic driving of the crane 1 or the like), the accuracy of the control can be improved.

### (Modifications)

As shown in FIG. 8, the attachment 14 may include the jib 115. The crane 1 may include a jib derricking device 127. The jib 115 is a member (derricking member) attached to the boom 15 so as to be raisable and lowerable. The jib 115 lifts the suspended load 21 via the winding rope 19a and the hook 19b.

The jib derricking device 127 is a device that raises and lowers the jib 115 with respect to the boom 15. The jib derricking device 127 includes a strut 127a, a jib guy line 127b, a strut guy line 127c, and a jib derricking rope 127d. The strut 127a (rear strut 127a1, front strut 127a2) is rotatably attached to the distal end of the boom 15 or the proximal end of the jib 115. The jib guy line 127b is connected to the distal end of the front strut 127a2 and the distal end of the jib 115. The strut guy line 127c is connected to the distal end of the rear strut 127al and, for example, the boom 15. The jib derricking rope 127d may be hung between a sheave of the rear strut 127al and a sheave of the front strut 127a2. The jib derricking rope 127d may be hung between a spreader (not shown) connected to the lower end of the strut guy line 127c and, for example, a spreader (not shown) provided in the boom 15. The jib derricking winch (not shown) mounted in the upper slewing body 11b or the boom 15 winds and unwinds the jib derricking rope 127d. Then, the distance between the distal end of the rear strut 127al and the distal end of the front strut 127a2 changes, or the strut 127a is raised and lowered with respect to the boom 15. As a result, the jib 115 is raised and lowered with respect to the boom 15. Note that only one strut 127a may be provided.

The attachment angle sensor 35 (see FIG. 2) includes a jib angle sensor that detects the derricking angle φ of the jib 115.

The hoisting height error ΔL is acquired as follows, for example. With the derricking angle θ of the boom 15 fixed, the hoisting height error ΔL is stored in the storage unit 51 (see FIG. 2) for various lifting loads F and various derricking angles φ of the jib 115. Then, the derricking angle θ of the boom 15 is changed in various ways, and the hoisting height error ΔL is stored in the storage unit 51 with various lifting loads F and various derricking angles φ of the jib 115 (see FIG. 2).

During the work of the crane 1, the arithmetic unit 53 (see FIG. 2) reads the hoisting height error ΔL corresponding to the configuration of the attachment 14, the derricking angle θ of the boom 15, the derricking angle φ of the jib 115, and the lifting load F. The arithmetic unit 53 calculates the hoisting height calculation value Lc (see FIG. 3) based on the derricking angle θ of the boom 15, the derricking angle φ of the jib 115, and the winding amount of the winding rope 19a. Then, the arithmetic unit 53 corrects the calculated hoisting height calculation value Lc by using the read hoisting height error ΔL.

### (Other Modifications)

The above embodiment may be modified in various ways. For example, the disposition and shape of each component of the embodiment may be changed. For example, the connection of each component shown in FIG. 2 may be changed. For example, the order of the steps in the flowcharts shown in FIGS. 3 and 6 may be changed, and some of the steps need not be performed. For example, the number of components may be changed, and some of the components need not be provided. For example, the components may be fixed or connected directly or indirectly. For example, a plurality of members and parts different from each other may be described as one member and part. For example, what has been described as one member and part may be divided into a plurality of different members and parts.

For example, components of the crane 1 in the above embodiment, for example, the storage unit 51, the arithmetic unit 53, the display unit 55, and the like may be provided outside of the crane 1. For example, the boom 15 may be a stretchable boom. In this case, the direction of deflection of the boom 15 is opposite to the deflection of the boom 15 shown in FIG. 1. Specifically, the boom 15 deflects to protrude downward in FIG. 1, but the stretchable boom deflects to protrude upward.

1. A hook position calculation device comprising:
a machine body that is a body of a crane;
an attachment attached to the machine body so as to be raisable and lowerable;
a winding rope suspended from the attachment;
a hook that is suspended from the attachment via the winding rope and is configured to attach a suspended load;
a winding winch that winds and unwinds the winding rope;
an attachment angle sensor that detects a derricking angle of the attachment;
a lifting load sensor that detects a lifting load acting on the winding rope;
a winding amount sensor that detects a winding amount of the winding rope by the winding winch;
a storage unit that stores hoisting height error information that is information about a hoisting height error associated with magnitude of the derricking angle and magnitude of the lifting load; and
an arithmetic unit that calculates a hoisting height calculation value that is a calculation value of a hoisting height of the hook based on a derricking angle detection value that is the derricking angle detected by the attachment angle sensor and a winding amount detection value that is the winding amount detected by the winding amount sensor,
wherein the hoisting height error is a difference between the hoisting height calculation value and an actual hoisting height of the hook, and
the arithmetic unit determines, by using the hoisting height error information, a hoisting height error corresponding value that is the hoisting height error corresponding to the derricking angle detection value and a lifting load detection value that is the lifting load detected by the lifting load sensor, and corrects the hoisting height calculation value based on the determined hoisting height error corresponding value.

2. The hook position calculation device according to claim 1, further comprising
an attachment configuration acquisition unit that acquires attachment configuration information that is information about a configuration of the attachment,
wherein the hoisting height error information is information about the hoisting height error associated with magnitude of the derricking angle, magnitude of the lifting load, and the configuration of the attachment, and
the hoisting height error corresponding value is the hoisting height error corresponding to the configuration of the attachment, the derricking angle detection value, and the lifting load detection value.

3. The hook position calculation device according to claim 1, wherein
the arithmetic unit calculates a horizontal distance from a proximal end of the attachment to the hook based on the determined hoisting height error corresponding value, the derricking angle detection value, and a length of the attachment.

4. The hook position calculation device according to claim 2, wherein
the arithmetic unit calculates a horizontal distance from a proximal end of the attachment to the hook based on the determined hoisting height error corresponding value, the derricking angle detection value, and a length of the attachment.
